(19) United States
(12) Patent Application Publication
(10) Pub. No.: US 2013/0162523 A1
(43) Pub. Date: Jun. 27, 2013

(54) SHARED WIRELESS COMPUTER USER INTERFACE

(71) Applicant: Dariusz Tomaszewski, San Jose, CA (US)

(72) Inventor: Dariusz Tomaszewski, San Jose, CA (US)

(73) Assignee: ADVANCED MICRO DEVICES, INC., Sunnyvale, CA (US)

(21) Appl. No.: 13/595,030

(22) Filed: Aug. 27, 2012

Related U.S. Application Data
(60) Provisional application No. 61/580,358, filed on Dec. 27, 2011.
(60) Provisional application No. 61/618,462, filed on Mar. 30, 2012.

(51) Int. Cl. G09G 5/00

(52) U.S. Cl. 345/156

(57) ABSTRACT

A system and method for use in a point-to-point enabled device includes establishing a wireless point-to-point connection with a remote device, transmitting a request message to the remote device requesting information to clone a user interface of the remote device at the point-to-point enabled device, receiving at the point-to-point enabled device the information to clone the user interface of the remote device, displaying on a display associated with the point-to-point enabled device a cloned image of the user interface of the remote device, receiving, at the point-to-point enabled device, user-entered input data associated with an application running on the remote device, and transmitting the user-entered input data from the point-to-point enabled device to the remote device via the wireless point-to-point connection. The transmitted user-entered input data is usable by the remote device as if that data was received at the remote device from a user of the remote device.

### CROSS REFERENCE TO RELATED APPLICATION

This application claims priority to U.S. Provisional Application No. 61/580,358, filed Dec. 27, 2011, and U.S. Provisional Application No. 61/618,462, filed Mar. 30, 2012, both of which are incorporated by reference as if fully set forth.

### TECHNICAL FIELD

The disclosed embodiments are generally directed to computer technology, and in particular to user interfaces.

### BACKGROUND

Portable or hand-held electronic devices with powerful computational and communication abilities are now common. Many such devices, such as some mobile (cellular) telephones, act as computers in that they may perform detailed calculations, display detailed graphics including video, and enable a user to send and receive information over a wireless network such as a mobile (wireless) version of the Internet. At the same time, such devices often have small and ergonomically inconvenient user interfaces, such as small, flat keyboards and other small touch-sensitive displays.

### SUMMARY OF THE EMBODIMENTS

A system and method for use in a point-to-point enabled device includes establishing a wireless point-to-point connection with a remote device, transmitting a request message to the remote device requesting information to clone a user interface of the remote device at the point-to-point enabled device, receiving at the point-to-point enabled device the information to clone the user interface of the remote device, displaying on a display associated with the point-to-point enabled device a cloned image of the user interface of the remote device, receiving, at the point-to-point enabled device, user-entered input data associated with an application running on the remote device, and transmitting the user-entered input data from the point-to-point enabled device to the remote device via the wireless point-to-point connection. The transmitted user-entered input data is usable by the remote device as if that data was received at the remote device from a user of the remote device.

### BRIEF DESCRIPTION OF THE DRAWINGS

A more detailed understanding may be had from the following description, given by way of example in conjunction with the accompanying drawings wherein:

FIG. 1A is a block diagram of an example device in which one or more disclosed embodiments may be implemented;

FIG. 1B is a block diagram of an alternate example device in which one or more disclosed embodiments may be implemented;

FIG. 2 shows a system for operation of a remote device, according to some embodiments.

FIG. 3 shows a method for operation of a remote device, according to some embodiments.

FIG. 4 shows a system for operation of a remote device, including high level system architecture, according to some embodiments.

FIG. 5 shows a method for operating a remote device, according to some embodiments.

### DETAILED DESCRIPTION

While small electronic devices, such as hand-held mobile phones, are becoming increasingly powerful, their user interfaces are limited in size, often making them ergonomically difficult to use effectively. For example, a small flat keyboard on a hand held device may be adequate for creating a short message, such as a text message. The same keyboard, however, would bring fatigue or, perhaps even injury over a long time, to a user creating a long document. An alternative is a larger, more ergonomic keyboard having the size of a keyboard commonly used with a desktop computer, for example. The larger keyboard may be in communication with the small device such that when a user types a key for a particular character on the large keyboard, information is sent to the small device that activates the corresponding key on the device keyboard, as though a user were typing directly on the small device keyboard.

More generally, one may envision a near-future in which the most powerful commonly used computational and communication devices will be small enough to be held in a hand or kept in a pocket or purse. The human interaction with such devices may be routinely carried out with larger, ergonomically convenient user interfaces. In addition to a keyboard, one might imagine interacting with such a small device using any interface type now known or yet to be invented. Examples of such interfaces include a microphone capturing voice commands, a virtual retinal display or a camera capturing a hand gesture as a command.

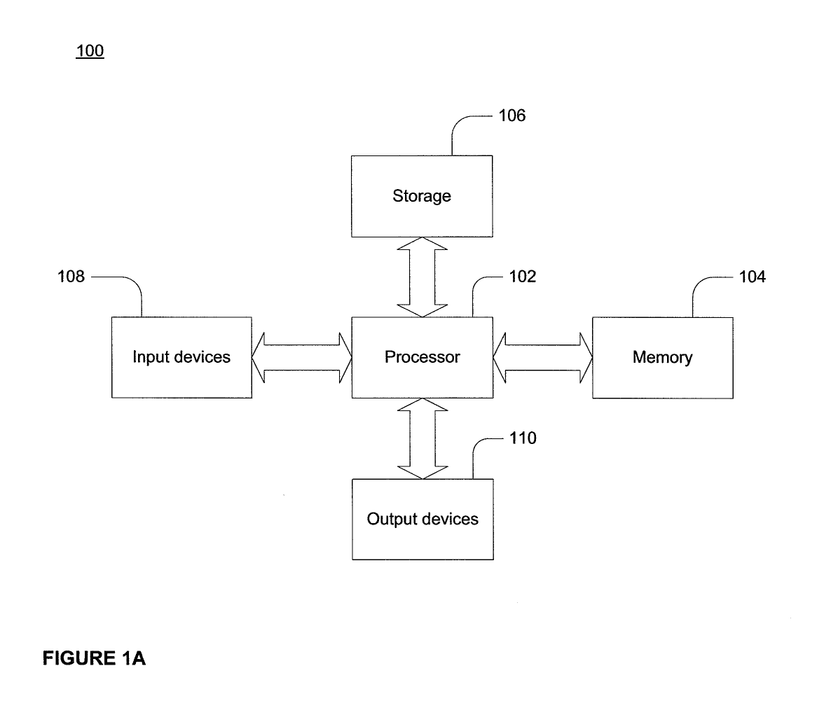

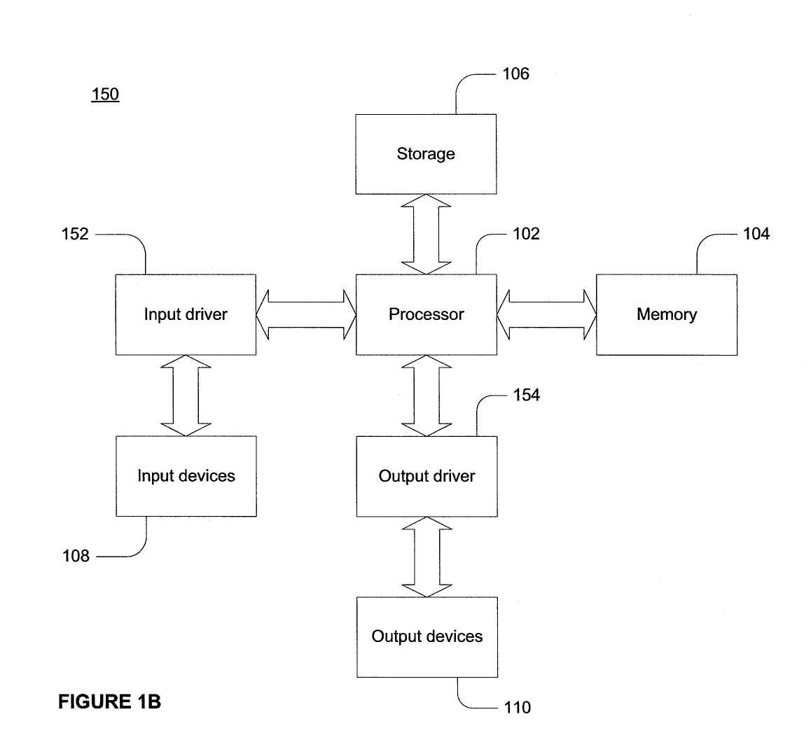

FIG. 1A is a block diagram of an example device 100 in which one or more disclosed embodiments may be implemented. Device 100 may be a portable computational or communication device as described above. Device 100 may also represent an ergonomically convenient user interface, as described above. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. Device 100 may include a desktop computer, a laptop computer, a wireless 2D or 3D display monitor with wireless keyboard, mouse, touchpad, camera or microphone for data or commands entry, virtual retinal display with real or virtual keyboard or touch pad and/or microphone for entry of voice data or commands, or an electronic tablet. It is understood that the device 100 may include additional components not shown in FIG. 1A.

The processor 102 may include a central processing unit (CPU), a graphics processing unit (GPU), a CPU and GPU located on the same die, or one or more processor cores, wherein each processor core may be a CPU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a real or projected keyboard, a real or projected keypad, a real or projected touch screen, a pointing device such as a mouse or a touch pad, a detector, a camera, a microphone, an accelerometer, a gyroscope, a biometric scanner, or a network connection (e.g., a wireless local area network card for transmission and/or reception of wireless IEEE 802 signals). The output devices 110 may include a real or projected display, a speaker, a printer, a haptic feedback device, one or more lights, an antenna, or a network connection (e.g., a wireless local area network card for transmission and/or reception of wireless IEEE 802 signals).

FIG. 1B is a block diagram of an alternate example device 150 in which one or more disclosed embodiments may be implemented. Elements of the device 150 which are the same as in the device 100 are given like reference numbers. In addition to the processor 102, the memory 104, the storage 106, the input devices 108, and the output devices 110, the device 150 also includes an input driver 152 and an output driver 154.

The input driver 152 communicates with the processor 102 and the input devices 108, and permits the processor 102 to receive input from the input devices 108. The output driver 154 communicates with the processor 102 and the output devices 110, and permits the processor 102 to send output to the output devices 110.

In some embodiments, the device 100 includes an ergonomically convenient user interface. In these embodiments, the device 100 is a point-to-point enabled device coupled to a remote portable computational device (not shown). The user interface is configured to act as a user interface to the remote portable device and device 100 may be in bidirectional communication with the remote portable computational device through at least one communication channel. The user interface and remote portable computational device may communicate with each other through a wireless channel.

In some embodiments, input devices 108 include a user input device configured to accept input from a human user. For example, the user input device may include a large keyboard commonly used on a desktop or virtual projected keyboard. Other examples of such input devices include a real or virtual projected keypad, a real or virtual projected keypad touch screen, a real or virtual projected keypad touch pad, a detector, a pointing device such as a mouse or trackball, a camera, webcam, or a microphone. Input devices 108 may also include a receiver configured to receive information transmitted by the remote portable computational device.

Output devices 110 may include a display, such as a desktop monitor, virtual projected display, 2D or 3D display with built-in or attached wireless transmitter. Output devices 110 may also include a transmitter configured to transmit information to the portable computational device, the information representing input to input devices 108. Output devices 110 may also include a display configured to display received information transmitted by the remote portable computational device.

Processor 102 may be configured to implement a method for operating the remote portable computational device using user interface 100. In some embodiments, a small display associated with the remote portable computational device acting as a user interface for, and attached to, the remote portable computational device, is represented on a display 110 of the user interface 100. Display 110 may be a magnified version of the display on the remote portable computation device.

Display 110 may display active elements such as alphanumeric keys or icons that are duplicates of corresponding elements on the small display. A user may activate one of these elements, such as striking a physical or virtual alphanumeric key or clicking on an icon using a pointing device. The activation of the element is detected by processor 102 which then causes transmitter 110 to transmit information to the remote portable computational device indicating which element has been activated. The information is received by a receiver in the remote portable computational device and processed, whereupon the corresponding element (key, icon, etc.) on the small device is automatically activated. In this way, the small remote portable computational device is controlled by the user using a larger, more ergonomically convenient, interface.

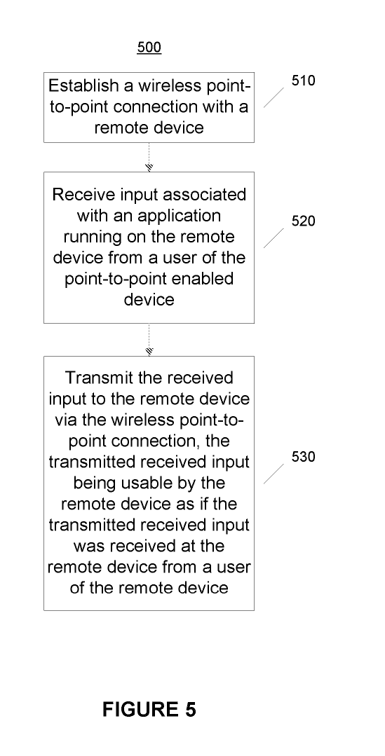

FIG. 5 shows a method 500 for operating a remote device, such as a remote portable computational device, using an ergonomic user interface situated at a point-to-point enabled device (e.g., the device 100), according to some embodiments. In some embodiments, the point-to-point enabled device is a peer-to-peer enabled device. The method 500 is described from the point of view of the point-to-point enabled device. A wireless point-to-point connection is established with a remote device 510. In some embodiments, the wireless point-to-point connection is a wireless peer-to-peer connection.

User-entered input associated with an application running on the remote device is received at the point-to-point enabled device from a user of the point-to-point enabled device 520. For example, the input may correspond to characters typed by a user on a virtual keyboard displayed within an image of a user interface of the remote device that is duplicated on a display associated with the point-to-point enabled device.

The point-to-point enabled device transmits the user-entered input to the remote device via the wireless point-to-point connection 530. The transmitted user-entered input is usable by the remote device as if the transmitted user-entered input was received from an input device of the remote device from a user of the remote device 530.

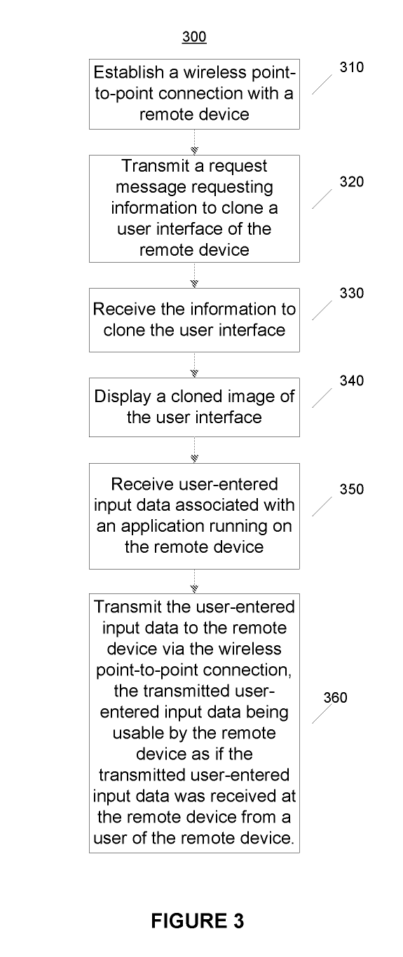

FIG. 3 shows a method 300 for operating a remote device, such as a remote portable computational device, using an ergonomic user interface situated at a point-to-point enabled device, according to some embodiments. The point-to-point enabled device may be a peer-to-peer enabled device. The method is described from the point of view of the point-to-point enabled device.

Referring to FIG. 3, a wireless point-to-point connection is established with the remote device 310. In some embodiments, the wireless point-to-point connection is a wireless peer-to-peer connection. A request message is transmitted requesting information to clone a user interface of the remote device at the point-to-point enabled device 320. The information to clone the user interface of the remote device is received at the point-to-point enabled device 330. A cloned image of the user interface of the remote device is displayed on a display associated with the point-to-point enabled device 340.

User-entered input data associated with an application running on the remote device is received at the point-to-point enabled device 350. For example, the input data may correspond to characters typed by a user on a virtual keyboard displayed within the cloned image of the user interface of the remote device. The user-entered input data is transmitted from the point-to-point enabled device to the remote device via the wireless point-to-point connection 360. The transmitted user-entered input data is usable by the remote device as if the transmitted user-entered input was received at the remote device from a user of the remote device.

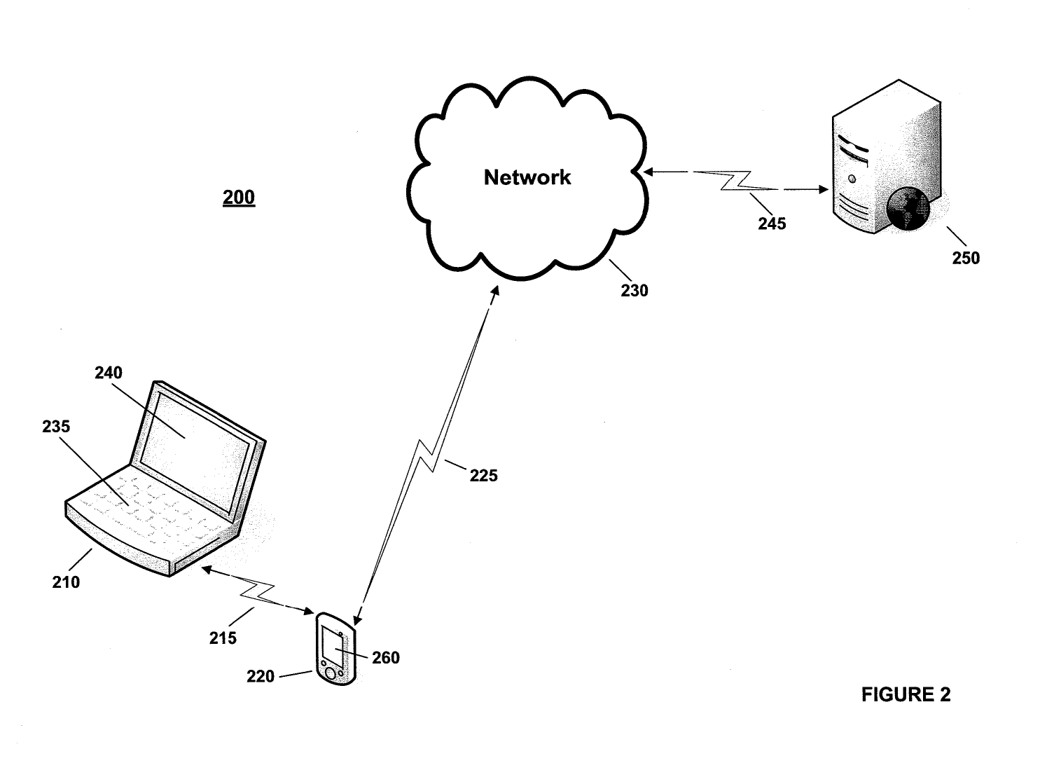

FIG. 2 shows a system for operation of a remote device, according to some embodiments. In these embodiments, not to be construed as limiting, a point-to-point enabled device 210, such as a laptop computer, communicates with a remote device 220, such as a mobile telephone through a bidirectional wireless channel 215. Bidirectional wireless channel 215 may include a wireless point-to-point connection that may be a wireless peer-to-peer connection. Point-to-point enabled device 210 may be configured to establish the wireless point-to-point connection with remote device 220. Wireless channel 215 may operate based on an IEEE 802 and/or Bluetooth standard. One such standard is designated Wi-Fi Direct, a type of protocol. Both point-to-point enabled device 210 and remote device 220 may include hardware and applications that make bidirectional communication possible using such standards. Tactile, video and audio communications may be accomplished if hardware in one of the two devices supports either Wi-Fi Direct or Wigig and/or Bluetooth standards, and hardware of the other device supports Wi-Fi, Wi-Fi Direct or Wigig and/or Bluetooth standard and additional system level and application software.

Point-to-point enabled device 210 may include a transmitter (not shown) configured to transmit a request message to the remote device requesting information to clone a user interface 260 of remote device 220 at the point-to-point enabled device 210. Point-to-point enabled device 210 may include a receiver (not shown) configured to receive the information to clone the user interface 260 of the remote device 220. Point-to-point enabled device 210 may include a display 240, configured to display a cloned image of user interface 260 of remote device 220. Point-to-point enabled device 210 may include a user input device 235, configured to receive user-entered input data associated with an application running on the remote device 220. The transmitter of point-to-point enabled device 210 may be further configured to transmit the user-entered input data to remote device 220 via wireless channel 215. The transmitted user-entered input data is usable by remote device 220 as if the transmitted received input data was received at remote device 220 from a user of remote device 220. Point-to-point enabled device 210 may also include a processor configured to communicate with user input device 235, the transmitter, the receiver, and display 240. The processor may be configured to implement a method including cloning of user interface 260 of remote device 220 at point-to-point enabled device 210.

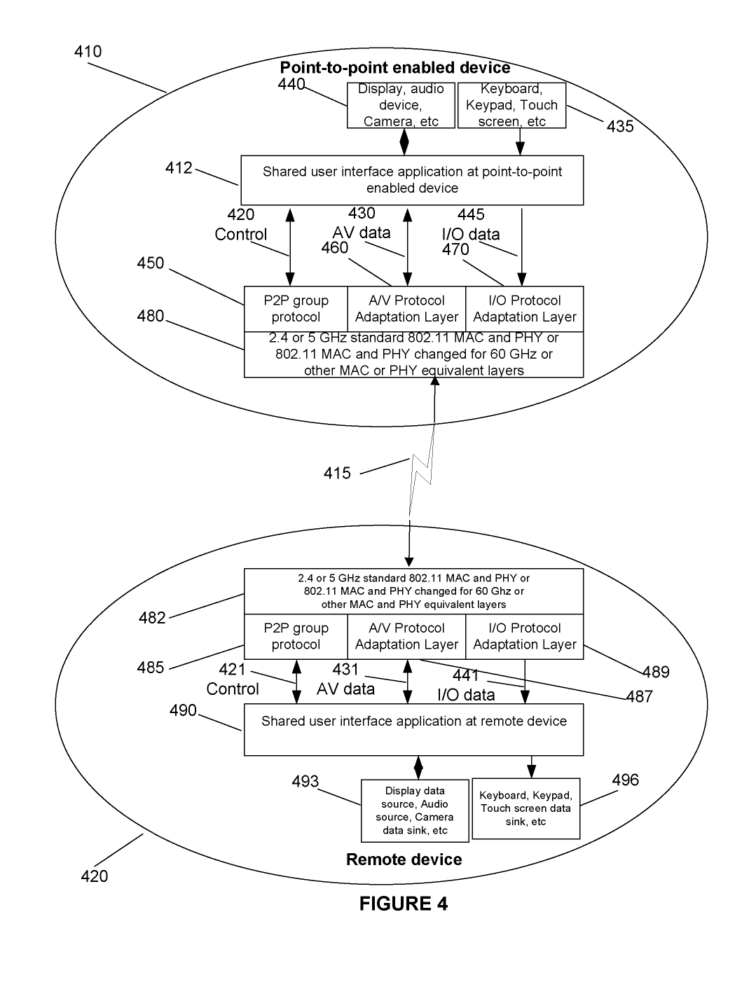

FIG. 4 shows high level system architecture of relevant parts of a system, such as that shown in FIG. 2, according to some embodiments. Transfer of user interface from a remote device 420 (e.g. a smart phone) to a point-to-point enabled device 410 (e.g. a laptop) is done according to the following sequence:

1. Remote device point-to-point (P2P) group protocol application 485 running on remote device 420 discovers P2P enabled 410 device when it is in a detection range. P2P group protocol application 485 may be implemented using Wi-Fi Direct standard, Bluetooth pairing or using another protocol.

2. A user of remote device 420 can select a device for Shared user interface (UI) connection from a list of detected devices available in Shared UI remote device application 490.

3. Shared user interface application 490 at remote device 420 uses P2P group protocol application 485 to initiate forming of a P2P group with point-to-point enabled device 410.

4. P2P group protocol application 450 and 485, at P2P enabled device 410 and remote device 420 respectively, executes provisioning phase which includes acceptance of group formation on P2P enabled device 410 by methods described in Wi-Fi Direct technical specification (e.g. entering a PIN) or other methods. Using 412 and 490 application the user decides whether to request creation of a persistent P2P group.

If user selects persistent P2P group, procedures 2 and 4 above are not required for sessions after the initial connection session until the group is deliberately dissolved.

5. Shared UI application 490 queries characteristics of display device 440 of P2P enabled device 410 through A/V Protocol Adaptation Layer application 487 and sets display data source of remote device 420 to output display data using supported display resolution and other display characteristics configured by the user using shared UI application 490. A/V Protocol Adaptation Layer 487 and A/V Protocol Adaptation Layer 460 at P2P enabled device 410 either follow Wigig standard, or use Wi-Fi Display specification, or use Bluetooth AVCTP and AVDTP protocols, or use other A/V protocols to transfer audio, video and auxiliary data.

Video, audio and auxiliary data may be encoded using Display Port, HDMI or another A/V protocol.

6. Application 490 initiates display and audio data streaming from display device 493 of remote device 420 to display device 440 through A/V Protocol Adaptation Layer application 487, MAC or PHY 482 at remote device 420, bidirectional wireless channel 415, MAC or PHY 480 at P2P enabled device 410, A/V protocol adaption layer 460 at P2P enabled device 410 and shared user interface application 412 at P2P enabled device 410 using one of the protocols listed in procedure 5 above.

7. Application 490 initiates streaming of data from feature 440, e.g. a camera, of P2P enabled device 410 to feature 493 of remote device 420, which may be a camera data sink through 412, 430, 460, 480, 415, 482, 487 and 490.

8. Application 490 initiates transfer of data obtained by at least one user input device 435 of P2P enabled device 410 to at least one user input device 493 of remote device 420 through 412, 445, 470, 480, 415, 482, 489, 441 and 490. I/O protocol adaption layers 489 and 470 of remote device 420 and P2P enabled device 410 respectively, may implement Wigig I/O Protocol Adaptation Layer or another I/O protocol. The data may be encoded using USB, Bluetooth Human Interface Device (HID) profile and Bluetooth Service Discovery Protocol application or another I/O protocol.

Overall, bidirectional communication between a remote device and a user interface may be implemented using an application including at least one of the following:

1. MAC layer or equivalent application 480 comprising: 2.4 GHz or 5 GHz standard 802.11 MAC Layer application or Bluetooth Link Manager, Bluetooth Audio and Bluetooth L2CAP protocol application;

2. Peer-to-peer group protocol application 450, 485 may include: Wi-Fi Direct or Bluetooth service discovery protocol and pairing application;

3. A/V Protocol Adaptation Layer application 460, 487 may include: Wigig standard or Wi-Fi Display, or Bluetooth AVCTP and AVDTP protocols application; or

4. I/O Protocol Adaptation Layer application 470, 489 may include: Bluetooth Human Interface Device (HID) profile and Bluetooth Service Discovery Protocol application, Wigig I/O Protocol Adaptation Layer application or another I/O protocol provided with a Wi-Fi MAC layer application.

Referring once again to FIG. 2, display 240 may also serve as an input device by, for example, displaying icons. User interface 260 of remote device 220 may display, for example, a virtual keyboard. Remote device 220 may be configured to exchange information with a third device 250, such as a server, over a network 230, such as a Local Area Network or the Internet. Communication between third device 250 and network 230 is over a bidirectional wireless channel 245.

A user may implement exchange of information between remote device 220 and third device 250 by entering a command using the virtual keyboard displayed on touch screen 260. The small virtual keyboard, however, may be ergonomically inconvenient to use. Instead, the user may enter a command using the user interface 235 at point-to-point enabled device 210. User interface 235 may be, for example a full-size keyboard. Each keystroke entered on user interface 235 may be communicated to remote device 220 through channel 215, whereupon the corresponding key of the virtual keyboard at remote device 220 is automatically activated. Remote device 220 transmits the entered command to network 225 as if the keystrokes had been entered directly on the virtual keyboard on user interface 260.

The command is transmitted through network 230 to third device 250, which may then respond by transmitting requested information back through network 230 to remote device 220. Remote device 220 then transmits the requested information to point-to-point enabled device 210 over wireless channel 215 where it is displayed on display 240. In this way, a user uses point-to-point enabled device 210 as an ergonomically convenient interface to control transmission of information by remote device 220 to third device 250 via a network 230, and to control information received by remote 220 from third device 250 via network 230.

Remote device 220 may be a mobile telephone, a portable digital assistant, a smart phone, an electronic tablet, clamshell, small laptop/ultra book, netbook, digital camera, or a video camera. Point-to-point enabled device 210 may be a laptop computer, a desktop computer, a wireless display monitor, an electronic tablet, a microphone, or a video camera.

In some embodiments, remote device 220 does not include a user interface of its own as a mechanically integral part. In these embodiments, all exchanges of information between a human user and remote device 220 or between remote device 220 and third device 250 are controlled through an interface that is not mechanically integrated with the remote device.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, application, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system, comprising:
a point-to-point enabled device; and
a remote device;
the point-to-point enabled device being configured to establish a wireless point-to-point connection with the remote device;
the point-to-point enabled device comprising:
a transmitter, configured to transmit a request message to the remote device requesting information to clone a user interface of the remote device at the point-to-point enabled device;
a receiver, configured to receive the information to clone the user interface of the remote device;
a display, configured to display a cloned image of the user interface of the remote device; and
a user input device configured to receive user-entered input data associated with an application running on the remote device;
wherein the transmitter is further configured to transmit the user-entered input data to the remote device via the wireless point-to-point connection, wherein the transmitted user-entered input data is usable by the remote device as if the transmitted user-entered input data was received at the remote device from a user of the remote device; and
a processor configured to communicate with the user input device, the transmitter, the receiver, and the display, the processor configured to implement a method comprising the cloning of a user interface of the remote device at the point-to-point enabled device.

2. The system of claim 1, wherein the point-to-point enabled device is a peer-to-peer enabled device and the wireless point-to-point connection is a wireless peer-to-peer connection.

3. The system of claim 2, wherein the wireless peer-to-peer connection is established using Wi-Fi Direct protocol or Bluetooth service discovery.

4. The system of claim 1, wherein the method implemented by the processor further comprises:
receiving, in the cloned image of the user interface of the remote device on the point-to-point enabled device, information to be transmitted to the third device via the remote device;
transmitting the information to the remote device for transmission to a third device; and
receiving, in the cloned image of the user interface of the remote device on the point-to-point enabled device, information from the third device via the remote device.

5. The system of claim 1, wherein the user input device comprises at least one of: a virtual or real keyboard, a virtual or real keypad, a touch screen, a virtual or real touch pad, a detector, a pointing device, a camera, or a microphone.

6. The system of claim 1, wherein the wireless point-to-point connection comprises one of: Wi-Fi 802.11 or Bluetooth IEEE 802.15.1.

7. The system of claim 1, wherein the first user interface is configured to communicate with the portable computational device bidirectionally using an application comprising at least one of:
MAC layer or equivalent application comprising of: 2.4 GHz or 5 GHz standard 802.11 MAC Layer application or Bluetooth Link Manager, Bluetooth Audio and Bluetooth L2CAP protocol application;
Point to Point group protocol application comprising: Wi-Fi Direct or Bluetooth service discovery protocol and pairing application;
A/V Protocol Adaptation Layer application comprising: Wigig standard or Wi-Fi Display, or Bluetooth AVCTP and AVDTP protocols application; or
I/O Protocol Adaptation Layer application comprising: Bluetooth Human Interface Device (HID) profile and Bluetooth Service Discovery Protocol application, Wigig I/O Protocol Adaptation Layer application or another I/O protocol provided with a Wi-Fi MAC layer application.

8. The system of claim 1, wherein the remote device is at least one of: a portable digital assistant, a smart phone, an electronic tablet, a clamshell, a small laptop or ultra book, a netbook, a digital camera, or a video camera.

9. The system of claim 1, wherein the point-to-point enabled device comprises at least one of: a desktop computer, a laptop computer, a wireless 2D or 3D display monitor with wireless keyboard, mouse, touchpad, camera or microphone for data or commands entry, virtual retinal display with real or virtual keyboard or touch pad and/or microphone for entry of voice data or commands, or an electronic tablet.

10. A method for use in a point-to-point enabled device, the method comprising:
establishing a wireless point-to-point connection with a remote device;
transmitting a request message to the remote device requesting information to clone a user interface of the remote device at the point-to-point enabled device;
receiving at the point-to-point enabled device the information to clone the user interface of the remote device; displaying on a display associated with the point-to-point enabled device a cloned image of the user interface of the remote device;
receiving, at the point-to-point enabled device, user-entered input data associated with an application running on the remote device; and
transmitting the user-entered input data from the point-to-point enabled device to the remote device via the wireless point-to-point connection, wherein the transmitted user-entered input data is usable by the remote device as if the transmitted user-entered input data was received at the remote device from a user of the remote device.

11. The method of claim 10, wherein the point-to-point enabled device is a peer-to-peer enabled device and the wireless point-to-point connection is a wireless peer-to-peer connection.

12. The method of claim 11, wherein the wireless peer-to-peer connection is established using Wi-Fi Direct protocol or Bluetooth service discovery.

13. The method of claim 10, further comprising:
receiving, in the cloned image of the user interface of the remote device on the point-to-point enabled device, information to be transmitted to the third device via the remote device;
transmitting the information to the remote device for transmission to a third device; and
receiving, in the cloned image of the user interface of the remote device on the point-to-point enabled device, information from the third device via the remote device.

14. The method of claim 10, comprising a user entering the user-entered input data at the cloned image of the user interface of the remote device using a user input device of the point-to-point enabled device, the user input device being at least one of: a virtual or real keyboard, a virtual or real keypad, a touch screen, a virtual or real touch pad, a detector, a pointing device, a camera, or a microphone.

15. The method of claim 10, wherein the point-to-point enabled device is configured to communicate with the portable remote device bidirectionally through at least one of an IEEE 802 channel or Bluetooth IEEE 802.15.1.

16. The method of claim 10, wherein establishing a wireless point-to-point connection comprises the use of an application comprising at least one of:
MAC layer or equivalent application comprising: 2.4 GHz or 5 GHz standard 802.11 MAC Layer application or Bluetooth Link Manager, Bluetooth Audio and Bluetooth L2CAP protocol application;
Point to Point group protocol application comprising: Wi-Fi Direct or Bluetooth service discovery protocol and pairing application;
A/V Protocol Adaptation Layer application comprising: Wigig standard or Wi-Fi Display, or Bluetooth AVCTP and AVDTP protocols application; or
I/O Protocol Adaptation Layer application comprising: Bluetooth Human Interface Device (HID) profile and Bluetooth Service Discovery Protocol application, Wigig I/O Protocol Adaptation Layer application or another I/O protocol provided with a Wi-Fi MAC layer application.

17. The method of claim 10, comprising using, as the remote device, a portable digital assistant, a smart phone, an electronic tablet, a clamshell, a small laptop or ultra book, a netbook, a digital camera, or a video camera.

18. The method of claim 10, comprising using, as the point-to-point enabled device, a desktop computer, a laptop computer, a wireless 2D or 3D display monitor with wireless keyboard, mouse, touchpad, camera or microphone for data or commands entry, virtual retinal display with real or virtual keyboard or touch pad and/or microphone for entry of voice data or commands, or an electronic tablet.

19. A non-transitory computer-readable storage medium comprising instructions that are acted upon by a program executable in a computer system, the program operating on the instructions to perform a method, the method comprising:
establishing a wireless point-to-point connection with a remote device;
transmitting a request message to the remote device requesting information to clone a user interface of the remote device at the point-to-point enabled device;
receiving at the point-to-point enabled device the information to clone the user interface of the remote device;
displaying on a display associated with the point-to-point enabled device a cloned image of the user interface of the remote device;
receiving, at the point-to-point enabled device, user-entered input data associated with an application running on the remote device; and
transmitting the user-entered input data from point-to-point enabled device to the remote device via the wireless point-to-point connection, wherein the transmitted user-entered input data is usable by the remote device as if the transmitted user-entered input data was received at the remote device from a user of the remote device.

20. The non-transitory computer-readable storage medium of claim 19, wherein the point-to-point enabled device is a peer-to-peer enabled device, and the wireless point-to-point connection is a wireless peer-to-peer connection.

21. The non-transitory computer-readable storage medium of claim 19, wherein the wireless peer-to-peer connection is established using Wi-Fi Direct protocol or Bluetooth service discovery.

22. The non-transitory computer-readable storage medium of claim 19, wherein the method further comprises:
receiving, in the cloned image of the user interface of the remote device on the point-to-point enabled device, information to be transmitted to the third device via the remote device;
transmitting the information to the remote device for transmission to a third device; and
receiving, in the cloned image of the user interface of the remote device on the point-to-point enabled device, information from the third device via the remote device.

23. The non-transitory computer-readable storage medium of claim 19, wherein the first user interface is configured to communicate with the portable computational device bidirectionally using an application comprising at least one of:
MAC layer or equivalent application 380 comprising of: 2.4 GHz or 5 GHz standard 802.11 MAC Layer application or Bluetooth Link Manager, Bluetooth Audio and Bluetooth L2CAP protocol application;
Point to Point group protocol application 350, 385 comprising: Wi-Fi Direct or Bluetooth service discovery protocol and pairing application;
A/V Protocol Adaptation Layer application 360, 387 comprising: Wigig standard or Wi-Fi Display, or Bluetooth AVCTP and AVDTP protocols application; or
I/O Protocol Adaptation Layer application 370, 389 comprising: Bluetooth Human Interface Device (HID) profile and Bluetooth Service Discovery Protocol application, Wigig I/O Protocol Adaptation Layer application or another I/O protocol provided with a Wi-Fi MAC layer application.
